(19) United States
(12) Patent Application Publication
(10) Pub. No.: US 2024/0396751 A1
(43) Pub. Date: Nov. 28, 2024

(54) METHOD AND COMPUTING DEVICE FOR PROOF-OF-WORK RELATED TO BLOCKCHAIN MINING

(71) Applicant: UniTract Co., LTD., Taipei City (TW)

(72) Inventor: Chih-Wen Hsueh, Taipei (TW)

(73) Assignee: UniTract Co., LTD., Taipei City (TW)

(21) Appl. No.: 18/273,786

(22) PCT Filed: Jan. 28, 2022
(86) PCT No.: PCT/CN2022/074477

§ 371 Date: Jul. 24, 2023

Related U.S. Application Data
(60) Provisional application No. 63/146,696, filed on Feb. 7, 2021.

(51) Int. Cl. H04L 9/00; G06Q 20/06

(52) U.S. Cl. CPC H04L 9/50; G06Q 20/065

(57) ABSTRACT

A method and a computing device for proof-of-work (PoW) related to blockchain mining are provided by embodiments of the present invention. The method includes receiving a block; determining whether hash values of multiple nonces corresponding to the block meet the condition, including in response to a first hash value of a first nonce among the plurality of nonces corresponding to the block meeting the condition, continuing to determine whether a second hash value of a second nonce among the plurality of nonces corresponding to the block meets the condition; and verifying at least two nonces that meet the condition among the plurality of nonces. In this way, the energy consumption problem of the blockchain may be solved, and a complete and accurate mathematical model estimable by the blockchain may be established to apply to various applications that guarantee confidence levels using mathematics.

### TECHNICAL FIELD

The present invention relates to a blockchain technology, in particular, to a method and a computing device for proof-of-work (PoW) related to block mining.

### DESCRIPTION OF RELATED ART

The terms “block” and “chain” were used respectively in the Bitcoin white paper, and then came the development of cryptocurrency. Before the name of blockchain was determined, the Bitcoin had been the first blockchain application proposed. With the development of the blockchain technology to date, in addition to the Bitcoin, there are more than 15,000 cryptocurrencies. In addition, various features of the blockchain have been developed today to meet the requirements for establishing trust in different applications in the Internet. For example, a smart contract is a trusted program that is verified by peer nodes.

It is worth noting that PoW is a cryptographic proof that enables a prover to prove to others (verifiers) that a certain amount of specific computational effort has been spent, and the verifier only needs to spend the least amount of effort to confirm. In addition, PoW may be expressed by sending partial data from the requester to the service provider. PoW was first proposed to avoid spam and is achieved by performing a sufficiently large amount of work before delivering the email. Hash-based PoW in Bitcoin is used to prove that sufficient computations have been done and allows the winner to append a new block. It is worth noting that the energy consumption problem of PoW is due to the need to compete for sufficient work in order to get high rewards early. Due to the limited supply and the centralized holding of the Bitcoin, price jumps of the Bitcoin have resulted in high rewards.

### SUMMARY

The present invention is directed to a method and a computing device for PoW related to block mining, which improves the confidence level and reduces the energy consumption by incrementing nonces.

According to an embodiment of the present invention, the method for POW related to block mining includes (but is not limited to) the following. A block is received. Whether hash values of multiple nonces corresponding to the block meet a condition is determined. In response to a first hash value of a first nonce among the multiple nonces corresponding to the block meeting the condition, it is continued to determine whether a second hash value of a second nonce among the multiple nonces corresponding to the block meets the condition. At least two nonces that meet the condition among the multiple nonces are verified.

According to an embodiment of the present invention, the computing device for PoW related to block mining includes (but is not limited to) a memory and a processor. The memory is used to store program codes. The processor is coupled to the memory. The processor is configured to load and execute the program codes to receive a block, determine whether hash values of multiple nonces corresponding to the block meet a condition and verify at least two nonces that meet the condition among the multiple nonces. In response to a first hash value of a first nonce among the multiple nonces corresponding to the block meeting the condition, the processor is further configured to continue to determine whether a second hash value of a second nonce among the multiple nonces meets the condition.

Based on the above, according to the method and the computing device for POW related to block mining of the embodiment of the present invention, even when the hash values of the multiple nonces meet the condition, whether other conditions such as time limit, handling fees, etc., are met are still calculated according to the data in the block. In this way, the energy consumption problem of the blockchain is solved and the confidence level is ensured.

### BRIEF DESCRIPTION OF THE DRAWINGS

The accompanying drawings are included to provide a further understanding of the present invention, and are incorporated in and constitute a part of this specification. The drawings illustrate the embodiments of the present invention and together with the description serve to explain the principles of the present invention.

FIG. 1 is a component block diagram of a computing device according to an embodiment of the present invention.

FIG. 2 is a flowchart of a method according to an embodiment of the present invention.

FIG. 3 is a flowchart of PoW according to an embodiment of the present invention.

FIG. 4 is a schematic diagram of PoW according to an embodiment of the present invention.

### DESCRIPTION OF THE EMBODIMENTS

Reference is made in detail to the exemplary embodiments of the present invention, and the examples of the exemplary embodiments are illustrated in the accompanying drawings. Wherever possible, the same reference numerals used in the drawings and descriptions refer to the same or similar parts.

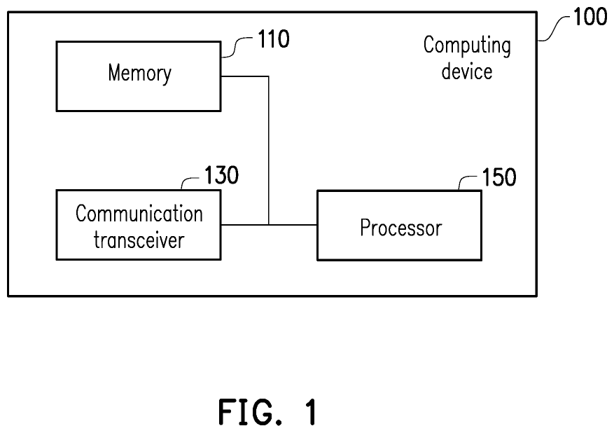

FIG. 1 is a component block diagram of a computing device 100 according to an embodiment of the present invention. Referring to FIG. 1, the computing device 100 includes (but is not limited to) a memory 110 and a processor 150. The computing device 100 may be a computer, a server, a smart phone, a tablet computer, a mining machine, or other electronic devices.

The memory 110 may be any type of fixed or removable random-access memory (RAM), a read-only memory (ROM), a flash memory, a similar device, or a combination of the above. The memory 110 records program codes, device configurations, buffer data, or permanent data (e.g., hash values, nonces, target values, or condition), which will be described later.

The processor 150 is coupled to the memory 110. The processor 150 is configured to load and execute the program codes stored in the memory 110 for carrying out programs of the exemplary embodiments of the present invention.

In some embodiments, the processor 150 may be a central processing unit (CPU), a microprocessor, microcontroller, a graphics processing unit (GPU), a digital signal processing (DSP) chip, a field programmable gate array (FPGA), or a neural network accelerator. The functions of the processor 150 may be implemented by a stand-alone electronic device or an integrated circuit (IC), and the operations of the processor 150 may be implemented by software.

In some embodiments, the computing device 100 also includes a communication transceiver 130. The communication transceiver 130 may be a communication interface or a wireless transceiver supporting, for example, Bluetooth, Wi-Fi, mobile communication, IR wireless communication, USB, Ethernet, optical fiber network, etc. In some embodiments, the communication transceiver 130 is used to communicate with an external device for receiving data from or transmitting data to the external device, for example, for receiving or transmitting a block.

In the following embodiments, the components and modules in the computing device 100 will be used to explain the method for POW related to block mining provided by the embodiment of the present invention. Each step of the method may be adjusted according to the actual implementation and should not be limited to the content described herein.

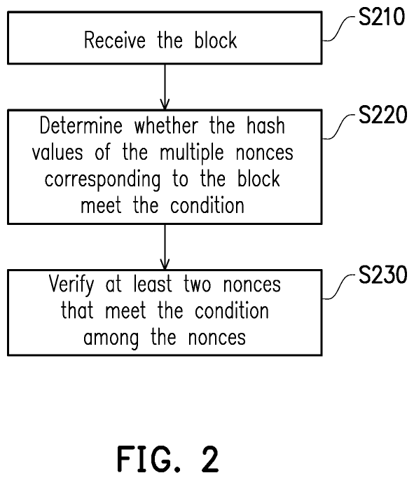

FIG. 2 is a flowchart of a method according to an embodiment of the present invention. Referring to FIG. 2, the processor 150 receives the block (step S210). For example, the processor 150 receives the block provided by the publisher, the server of the service provider or the other nodes through the communication transceiver 130. As another example, the processor 150 receives the block stored in the storage device via an input interface (not shown in the figure). However, the embodiment of the present invention does not limit the source or the generation method of the block.

The processor 150 determines whether the hash values of the multiple nonces corresponding to the block meet the condition (step S220). Specifically, in order to obtain the PoW, a specific algorithm is used whereby the result of the algorithm is computed by spending time and computing resources. For example, the Bitcoin blockchain uses a hash algorithm as PoW, allowing each node to generate via PoW computations a valid new block which is verified via the other nodes.

In one embodiment, the header of the block includes a nonce. The processor 150 may combine the nonce with other data (data from the header of the block or other sources), and substitute the hash function for the mixed value of the two (i.e., the value after combining the nonce with other data) to obtain hash value. In one embodiment, the processor 150 may determine whether the hash value of one or more of the nonces corresponding to the block is not greater than the target value. When the hash value is greater than the target value, the processor 150 regards the hash value as not meeting the condition. When the hash value is not greater than (e.g., less than or equal to), the processor 150 regards the hash value as meeting the condition. That is, the condition of the embodiment is to be not greater than the target value. However, in other embodiments, the processor 150 may use nonces to perform other computations to obtain fairly random values such as hash values.

In one embodiment, the processor 150 may change the nonce when the hash value does not meet the condition. For example, adding one to a nonce, adding a specific value, or using a specific mathematical formula. Next, the processor 150 obtains the hash value based on the new nonce and determines whether the hash value meets the condition.

In one embodiment, in response to the first hash value of the first nonce among the multiple nonces corresponding to the block meeting the condition, the processor 150 continues to determine whether the second hash value of the second nonce among the multiple nonces corresponding to the block meets the condition. That is to say, when the hash value meets the condition, the processor 150 may change the first nonce to generate the second nonce. Next, the processor 150 obtains the hash value based on the second nonce and determines whether the hash value meets the condition.

In one embodiment, the processor 150 may determine whether the number of those nonces meeting the condition is equal to m. m is a positive integer greater than 0, for example, 2, 5, or 8. That is to say, as long there are nonces meeting the condition, the processor 150 collects or stores the nonces in the memory 110 until the number of the nonces meeting the condition is equal to m. In some application scenarios, where m=1 is equivalent to the Bitcoin practice. Where m=2 is equivalent to the estimatable PoW (EPoW). The embodiment is called the conservative general PoW (GPoW).

In one embodiment, a confidence level C of the estimated computing power of the GPoW is related to m. For example, the probability that a conservative GPOW collects exactly m nonces in n trials is shown in the following formula (3), and the average value of n is used to estimate the computing power (inversely proportional). According to the Bayes' Theory, assuming that the probability of each trial is 1/n, the coefficient of variation of the estimated computing power is CV=m+1/m²+m+1. The confidence level C of the estimated computing power is 1 minus the coefficient of variation CV. That is, C=1−CV. For example, in trials where m=10, the confidence level may be as high as 90.09%. If m=1000, the confidence level is even close to 99.9%. In one embodiment, the processor 150 may determine m according to the confidence level C and/or the coefficient of variation CV. For example, the value of the confidence level C is first set and then the minimum m is solved, so that the formula is less than 1−C.

In one embodiment, the processor 150 may determine whether the number of those nonces meeting the condition is equal to m′. m′ is a positive integer greater than m, for example, 10, 6, or 7. That is to say, even if the m nonces meeting the condition have been collected, as long as there are other nonces meeting the condition, the processor 150 collects or stores the nonces in the memory 110 until the number of the nonces meeting the condition is equal to m′. m′ is a number that may be customized by each node. As long as m′ nonces are found in the time less than half of the block interval, and do not lag behind the time when the block was first sent, there is a chance for being accepted. The embodiment is called the aggressive GPoW.

In one embodiment, the m-th order statistics is also related to a beta distribution. The beta distribution may be used to explain the behavior of hash-based PoW premised on m, and will be described in detail in subsequent embodiments.

The processor 150 may verify at least two nonces that meet the condition among those nonces (step S230). In one embodiment, the processor 150 may send or broadcast at least two nonces that meet the condition to the other nodes through the communication transceiver 130 and verify whether the hash values of these nonces actually meet the condition through the other nodes. In another embodiment, the processor 150 may also receive at least two nonces sent from the other nodes through the communication transceiver 130 and verify whether the hash values of these nonces actually meet the condition. These nonces computed by a certain node may be recorded in the header of the block, and the other nodes may verify whether the block meets the condition.

In one embodiment, in response to the number of the nonces meeting the condition being equal to m or equal to m′, the processor 150 may send the m nonces through the transceiver 130 for verification. For example, the m nonces are recorded in the block, and the block is broadcasted.

In one embodiment, in response to the verification that the data in the block all successfully meets the condition, the processor 150 may update the new block. For example, if the hash values of the m nonces meet the condition (for example, the estimated computing power being within the allowable range, the common ancestor block being within the specified range, the handling fee being within the applicable range, etc.), the processor 150 may select the block having the earliest powertimestamp, which is earlier than a time difference range, or otherwise having a greater computing power, so as to reset the current block and update to the latest block. The updating of the block may be achieved by receiving another block as described in step S210.

In one embodiment, the processor 150 may determine the estimated computing power of the PoW according to the average value of the hash values of the minimum m nonces meeting the condition.

In one embodiment, the processor 150 may determine that the nonce successfully meets the condition according to the result of the estimated computing power being within +200% range or other allowable ranges of the estimated computing power of the grandfather block.

In one embodiment, the processor 150 may determine that the nonce successfully meets the condition according to the result that the common ancestor block is above the block containing the grandfather block.

In one embodiment, the processor 150 may determine that the nonce successfully meets the condition according to the result that the handling fee is zero.

In one embodiment, the processor 150 may set the time difference range of the computing power according to the network time error (e.g., one tenth of a second).

Assuming that only the m hash values required to generate the m nonces of one GPoW block are counted here, the GPOW proposed in the embodiment of the present invention reduces a lot of energy consumption compared to the Bitcoin (even all the traditional PoWs) in terms of measurement.

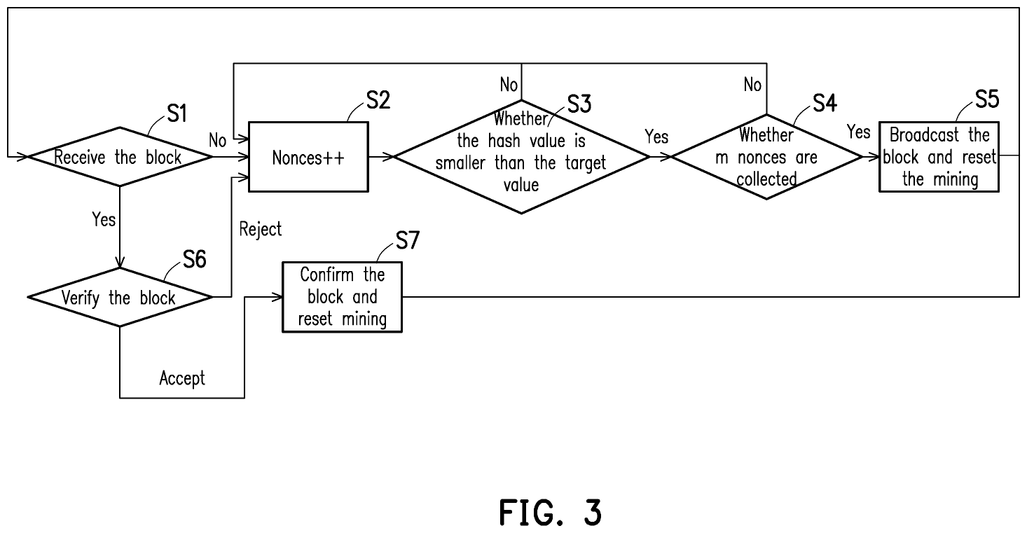

The following describes the overall flow of POW based on the hash function (which may be implemented by the computing device 100 or other devices). FIG. 3 is a flowchart of PoW according to an embodiment of the present invention. Referring to FIG. 3, it is determined whether the block has been received (step S1). The nonce is incremented (step S2). For example, 1 is added to the nonce. It is determined whether the hash value derived from the nonce of the header of the block is not greater than the target value (step S3). It is determined whether the m nonces having a hash value not greater than the target value are collected (step S4). If the m nonces have not been collected, the nonces are disabled/stopped/disallowed from being broadcasted to the other nodes for verification, and the nonces are continued to be incremented. If the m nonces are collected, the block including the m nonces is broadcasted to the other nodes for verification to confirm whether the mining is successful, and the mining is reset (step S5). On the other hand, the mined blocks may be verified (step S6). If the verification is failed (i.e., rejected), the nonce is incremented (step S2) and the hash value of the nonce is derived. If the verification is successful (i.e., accepted), the block is confirmed and the mining is reset (step S7).

It is worth noting that GPOW continues EPOW and extends the consensus mechanism from one PoW of EPOW with two nonces to the m nonces. That is, the m nonces are collected to make the hash function or other computed values of the block header to be less than a specific target value 1. Among them, these nonces are included in the header of the block, and EPOW is an extension of the consensus mechanism from PoW of the Bitcoin (with only one nonce included). m, nonce and hash value are all positive integers. The conservative GPOW is so-called because after expanding to the m nonces, when m nonces are collected, the mined block is broadcasted. The positive GPOW further extends to m′ nonces, and after having collected the m nonces, more interested nonces are collected until satisfaction, for example, to find a higher maximum hash value, a lower minimum average hash value (representing the real computing power), or even a higher other next-highest hash value, etc. GPW mainly solves the energy consumption problem of the blockchain and establishes a complete and accurate mathematical model estimable by the blockchain to carry out various applications that guarantee confidence levels using mathematics. The acceptance or reward of a block is usually based on the real computing power, and of course, can also be based on the formula formed by the hash values that are represented by the other nonces. Therefore, which m nonces to be selected for broadcasting from the m′ nonces results from different considerations, and is even related to the setting of the m value.

GPOW may broadcast the collected m nonces in the block header for verification in the way according to the Bitcoin and EPoW. The key is how the target value is set so that the above coefficient of variation represents the confidence level of the estimated computing power. The simultaneous equations of the average number of trials N̅ and the average value X̅ of the maximum hash value is first solved, in which it represents the most stable and trustworthy system state that will appear after several trials. After obtaining the solutions n and x respectively, the relationship between x and the target value t can be solved. For example, the weights of an individual formula may be set to solve the extreme value solution or the numerical solution, or like Bitcoin, the target value is dynamically adjusted according to history so that the coefficient of variation or the confidence level is within a predetermined range, and the target value is adjusted so that the number of blocks in each successful mining verification is within a certain range to improve efficiency. Since x must not be greater than t for mining to be successful, x≤t<T, where the integer T is the maximum value of the hash value. Therefore, the smaller the value of/minus x, the more stable or trustworthy the system is. The larger the value of t, the easier it is for mining block to be successful, so the most trustworthy/that is the hardest to mine is x, and the t that is the easiest is T−v, where vis the smallest unit value distinguishable by the hash value in the system, which is 1 when not normalized. If the variable X₍ᵢ₎ is normalized to be between 0 and 1, v is 1/T, and the relationship between x and/becomes x≤t<1. The system that operates according to the target value/set in this way is credible and controllable, and even t=x+wv may be set, where the larger the w≥1, the greater the operating flexibility of each parameter allowed by the system. Starting with the controllable estimated computing power, other related system functions may be further designed, and even if part of the system design is not related to the computing power, such as the real-name system or the anonymity system, it may also be indirectly used after the computing power is controllable to prevent Sybil attacks related to the computing power, and the computing power that reduces the energy consumption may even be used in the optimization design of any system, such as the distributed synchronization and the global event ordering. Therefore, the invention of GPOW solves all the technical problems of the current blockchain, and except for the resistance of the old forces with vested interests and the conservative view of the human nature, there are no problems that cannot be solved.

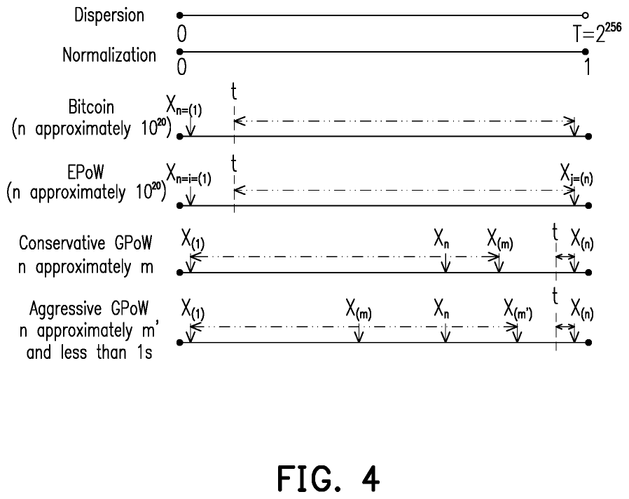

FIG. 4 is a schematic diagram of PoW according to an embodiment of the present invention. Referring to FIG. 4, it is assumed that the hash value is a value from 0 to 2²⁵⁶−1, that is, the maximum hash value is T=2²⁵⁶−1. The hash value is an integer uniformly distributed in [0, T=2²⁵⁶], and may be normalized to a standard continuous uniform distribution [0,1] when the value 2\hat{ }256 is added to apply to the analysis of beta distribution or other distributions. T is the normalized target value, n is the total number of computing trials, m is the number of the nonces required to meet the condition (also the required number of trials meeting the condition), and m′ is the number of all nonces meeting the condition (also the total number of trials meeting the condition). Among them, 1 s is also one second, which means that in an embodiment, the block interval is half of 2 seconds to estimate the maximum value of m′. Based on the concept of order statistics, Xₖ is the hash value of the kth trial, and X₍ₖ₎ is the kth largest hash value. Suppose Xᵢ₌₍₁₎ is the minimum hash value, and Xⱼ₌₍ₙ₎ is the maximum hash value. Therefore, Xₙ₌₁₌₍₁₎ is the last trial with the minimum hash value. Note that the bottom Xₙ in the figure may appear anywhere between the maximum hash value and the minimum hash value.

Suppose that any random variables X₁, X₂, . . . , Xₙ are given, and the order statistics X₍₁₎, X₍₂₎, . . . , X₍ₙ₎ are also random variables (e.g., values of the random variables X₁, X₂, . . . , Xₙ are sorted in increasing order). For an independent random variable, the order statistics uniformly distributed over a unit interval have a marginal distribution that belongs to the beta distribution family. For the samples of the random variables X₁, X₂, . . . , Xₙ, it is assumed that there are the cumulative distribution function (CDF) F_{X}(x) and the probability density function (PDF) f_{X}(x)=F′_{X}(x). The cumulative distribution function of the order statistics for these samples is:

$${F}_{{X}_{( m )}} ( x ) = {\sum }_{i = m}^{n} ( \begin{matrix}n \\ i\end{matrix} ) {( {F}_{X} ( x ) )}^{i} {( 1 - {F}_{X} ( x ) )}^{n - i} \qquad ( 2 )$$

and the corresponding probability density function is:

$${f}_{{X}_{( m )}} ( x ) = m ( \begin{matrix}n \\ i\end{matrix} ) {f}_{X} ( x ) {( {F}_{X} ( x ) )}^{m - 1} {( 1 - {F}_{X} ( x ) )}^{n - m} . \qquad ( 3 )$$

That is, F_{X}_{₍ₘ₎}(x) is the probability of an event of at least m variables among random variables X₁, X₂, . . . , Xₙ not greater than x. Also, F_{X}_{₍ₘ₎}(x)=P(X₍ₘ₎≤x). The probability is the same as the probability of at least m hash values that are not greater than the target value x in n trials.

Assuming Uₖ=F_{X}(Xₖ) is defined to obtain the corresponding random samples U₁, . . . , Uₙ from a standard uniform distribution. The order statistics also satisfy U₍ᵢ₎=F_{X}(X₍ᵢ₎). For the F_{U}(u)=u given by a standard uniform distribution, f_{U}(u)=1 The probability density function of the m-th order statistics U₍ₘ₎ is:

$${f}_{{U}_{( m )}} ( u ) = m ( \begin{matrix}n \\ m\end{matrix} ) {{u}^{m - 1} ( 1 - u )}^{n - m} \qquad ( 4 )$$

That is, the m-th order statistics in a uniform distribution is a beta-distributed random variable. For example, U₍ₘ₎˜Beta (m, n−m+1). Among them, assuming that u is given the target value t, the behavior of the normalized GPOW mining having at least m nonces is U₍ₘ₎. It can be seen that the statistical equation in a beta distribution can be applied to the GPOW mining.

Based on the above, in the method and the computing device for PoW related to block mining of the embodiment of the present invention, the number of nonces used for a single block mining is incremented to provide the target value of the estimable computing power having a high confidence level and provide a mathematical model applicable to the m or m′ nonces. In this way, attacks may be effectively prevented, power consumption reduced, confidence levels increased, and/or security or system resiliency improved.

It should be noted at last that the embodiments above are for purposes of describing the technical solutions of the present invention, and the embodiments are not intended to limit the present invention. Although the present invention has been described in detail with reference to the embodiments above, it should be understood that any person skilled in the art can make modifications to the technical solutions disclosed in the embodiments above, or perform equivalent replacements on some or all of the technical features. The essence of these modifications or replacements do not depart from the scope of the technical solutions disclosed in the embodiments of the present invention.

1. A method for proof-of-work (PoW) related to blockchain mining, implemented by a processor, and the method comprising:
receiving a block;
determining whether hash values of a plurality of nonces corresponding to the block meet a condition, comprising
in response to a first hash value of a first nonce among the plurality of nonces corresponding to the block meeting the condition, continuing to determine whether a second hash value of a second nonce among the plurality of nonces corresponding to the block meets the condition; and
verifying at least two nonces that meet the condition among the plurality of nonces.

2. The method for proof-of-work (PoW) related to blockchain mining according to claim 1, wherein determine whether the hash values of the plurality of nonces corresponding to the block meet the condition comprises:
determining whether a hash value of a block header where the plurality of nonces corresponding to the block are located is not greater than a target value.

3. The method for proof-of-work (PoW) related to blockchain mining according to claim 1, further comprising:
determining whether the number of nonces that meet the condition among the plurality of nonces is equal to m, where m is a positive integer greater than zero.

4. The method for proof-of-work (PoW) related to blockchain mining according to claim 3, further comprising:
determining whether the number of nonces that meet the condition among the plurality of nonces is equal to m′, where m′ is a positive integer greater than m, and a m′-th order statistic is related to a beta distribution.

5. The method for proof-of-work (PoW) related to blockchain mining according to claim 3, further comprising:
sending m nonces for verification, in response to the number of nonces that meet the condition among the plurality of nonces being equal to m.

6. The method for proof-of-work (PoW) related to blockchain mining according to claim 4, further comprising:
sending m nonces for verification, in response to the number of nonces that meet the condition among the plurality of nonces being equal to m′.

7. The method for proof-of-work (PoW) related to blockchain mining according to claim 1, further comprising:
updating a new block, in response to verifying the at least two nonces that meet the condition among the plurality of nonces being successful.

8. The method for proof-of-work (PoW) related to blockchain mining according to claim 3, further comprising:
determining a computing power according to an average of hash values of m nonces having less hash value that meet the condition.

9. A computing device for proof-of-work (PoW) related to blockchain mining, comprising:
a memory, for storing program codes; and
a processor, coupled to the memory, and configured to load and execute the program codes to:
receive a block;
determine whether hash values of a plurality of nonces corresponding to the block meet a condition, comprising
in response to a first hash value of a first nonce among the plurality of nonces corresponding to the block meeting the condition, continuing to determine whether a second hash value of a second nonce among the plurality of nonces corresponding to the block meets the condition; and
verify at least two nonces that meet the condition among the plurality of nonces.

10. The computing device for proof-of-work (PoW) related to blockchain mining according to claim 9, wherein the processor is further configured to:
determine whether the hash values of the plurality of nonces corresponding to the block are not greater than a target value.

11. The computing device for proof-of-work (PoW) related to blockchain mining according to claim 9, wherein the processor is further configured to:
determine whether the number of nonces that meet the condition among the plurality of nonces is equal to m, where m is a positive integer greater than zero.

12. The computing device for proof-of-work (PoW) related to blockchain mining according to claim 11, wherein the processor is further configured to:
determine whether the number of nonces that meet the condition among the plurality of nonces is equal to m′, where m′ is a positive integer greater than m, and a m′-th order statistic is related to a beta distribution.

13. The computing device for proof-of-work (PoW) related to blockchain mining according to claim 11, wherein the processor is further configured to:
send m nonces for verification, in response to the number of nonces that meet the condition among the plurality of nonces being equal to m.

14. The computing device for proof-of-work (PoW) related to blockchain mining according to claim 12, wherein the processor is further configured to:
send m nonces for verification, in response to the number of nonces that meet the condition among the plurality of nonces being equal to m′.

15. The computing device for proof-of-work (PoW) related to blockchain mining according to claim 9, wherein the processor is further configured to:
update a new block, in response to verifying the at least two nonces that meet the condition among the plurality of nonces being successful.

16. The computing device for proof-of-work (PoW) related to blockchain mining according to claim 11, wherein the processor is further configured to:
determine a computing power according to an average of hash values of m nonces having less hash value that meet the condition.
